(19) United States
(12) Patent Application Publication
(10) Pub. No.: US 2025/0346617 A1
(43) Pub. Date: Nov. 13, 2025

(54) Anticancer rhenium complexes against breast, colon, and pancreatic cancers

(71) Applicant: Morgan State University, Baltimore, MD (US)

(72) Inventor: Santosh Mandal, Parkville, MD (US)

(21) Appl. No.: 19/206,780

(22) Filed: May 13, 2025

Related U.S. Application Data
(60) Provisional application No. 63/646,025, filed on May 13, 2024.

(51) Int. Cl. C07F 13/00

(52) U.S. Cl. CPC C07F 13/00

(57) ABSTRACT

Novel bathophenanthroline and bathocuproin α-diimine rhenium tricarbonyl complexes PR6 and PR7 are shown to be effective in inhibiting growth of prostate, pancreatic and colon cancer cell lines.

### RELATED APPLICATIONS

This application claims priority to U.S. Provisional Application Ser. No. 63/646,025, the entirety of which is incorporated herein by reference.

### FIELD OF THE INVENTION

The invention relates to the treatment of various forms of cancers by various compounds.

### BACKGROUND OF THE INVENTION

Among prior art, U.S. Patent Application No. 20150299233 describes a process using rhenium-oxo compounds to treat cancer. U.S. Patent Application No. 20210317151 refers to methods that could benefit from ER stress induction through administration of a rhenium complex to treat cancers. In the paper entitled ‘In Vitro Biological Activity of α-Diimine Rhenium Dicarbonyl Complexes and Their Reactivity with Different Functional Groups,” by Schindler et al, the rhenium complexes contain bromide precursors. In the Simpson, et al paper “Defining the Anti-Cancer Activity of Tricarbonyl Rhenium Complexes: Induction of G2/M Cell Cycle Arrest and Blockade of Aurora-A Kinase Phosphorylation,” a rhenium complex is described that also contains bromine and CO compounds.

### SUMMARY OF THE INVENTION

Cancer is a worldwide health problem and is currently the second largest cause of death in the United States with an expected mortality rate of 608,750 people in 2021. While treatments are available, cancers are becoming resistant to current platinum-based treatment options. One possible alternative to platinum is rhenium. Rhenium is less toxic than platinum to non-cancerous cells while still providing anticancer functionality. For this reason, ten novel rhenium-based compounds, designated PR1-PR10, were synthesized using Mandal's Synthesis and studied to determine their anti-cancer properties.

Another set of rhenium compounds, referred to herein as the CH series, was previously found to target tubulin. This finding is extremely significant, as the mechanisms of action for rhenium's anti-cancer properties has not been conclusively determined. Testing with the PR series of rhenium compounds on cancer cells to observe the effects on tubulin was conducted to determine whether rhenium may target tubulin or whether it was some other component of the CH series that targeted tubulin. For this reasoning, it was decided to perform the same set of experiments on the PR series compounds using LNCaP prostate cancer cell lines.

Two of the PR series of rhenium-based compounds, designated PR6 and PR7, were shown to inhibit the growth of breast, colon and pancreatic cancer cells.

### BRIEF DESCRIPTION OF DRAWINGS

FIG. 1 shows the structure of the compound designated PR6.

FIG. 2 shows the structure of the compound designated PR7 compound.

FIG. 3 shows the synthesis of PC1-PC10.

FIG. 4 shows the synthesis of PR1-PR10 from PC1-PC10+HReO₄ compound.

FIG. 5 is an IR spectrum of PR6 in CH2Cl2. In the IR, the 3 carbonyl groups are shown to form 3 peaks to ensure the synthesis was complete.

FIG. 6 is an IR spectrum of PR7 in CH2Cl2. In the IR, the 3 carbonyl groups are shown to form 3 peaks to ensure the synthesis was complete.

FIG. 7 shows the X-Ray structure of PR6. The x-ray structure confirms the rhenium core, perrhenate, and ligand predicted from the line structure.

FIG. 8 shows X-Ray structure of PR7. The x-ray structure confirms the rhenium core, perrhenate, and ligand predicted from the line structure.

FIG. 9A is a chart showing absorbance at wavelengths ranging from 570 nm to 630 nm of colon cancer cell line CR-HCT-116 treated with PR6 and PRC7 in an MTT assay.

FIG. 9B is a chart showing is a chart showing absorbance at wavelengths ranging from 570 nm to 630 nm of colon cancer cell line CR-HCT-29 treated with PR6 and PRC7 in an MTT assay.

FIG. 10 is a chart showing absorbance at 570 nnm of pancreatic cancer cell lines treated with cisplatin-PR6 adduct formation.

FIG. 11 is a chart showing growth reduction of six different cancer cell lines subjected to cisplatin-PR7 adduct formation.

### DETAILED DESCRIPTION OF THE INVENTION

PR6 and PR7 rhenium-based compounds disclosed herein have the same rhenium core attached to 3 carbonyl groups. Attached to that core is a perrhenate and a ligand.

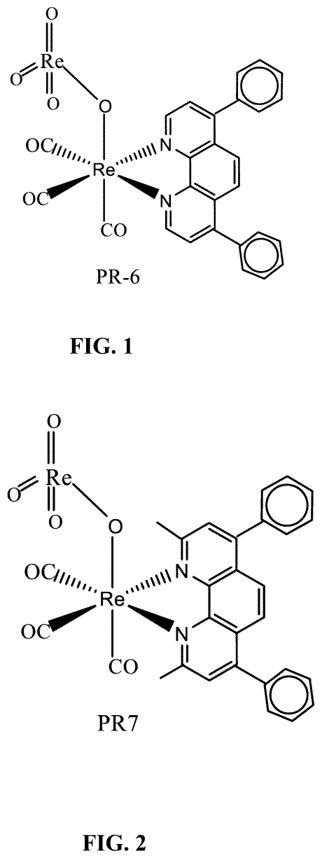

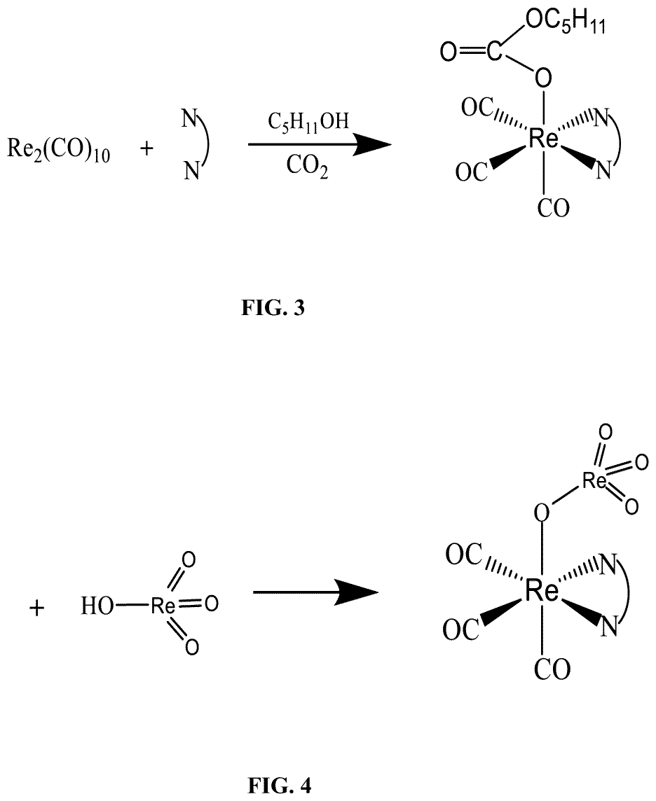

The complexes were obtained through Mandal's Synthesis which involves the treatment of a pentylcarbonato complexes with perrhenic acid (HReO₄) (FIGS. 3 and 4). In all, ten complexes were developed. Two of them, designated respectively as PR6 (FIG. 1) and PR7 (FIG. 2), were shown to have significant anti-cancer activity.

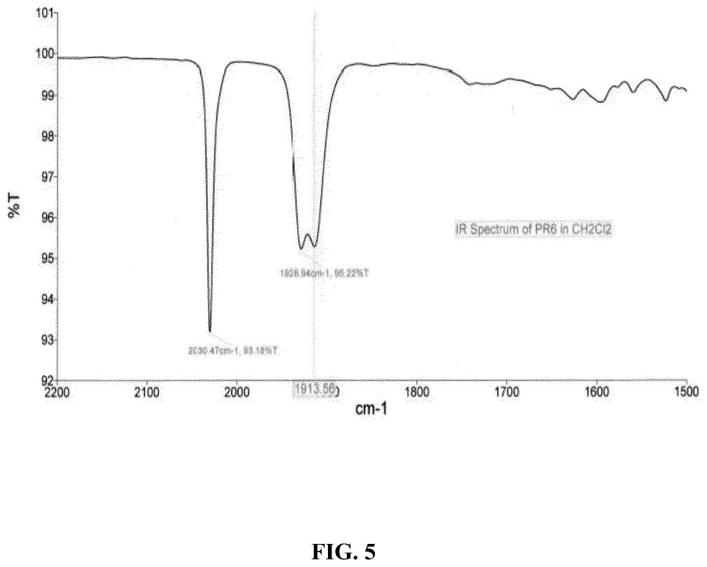

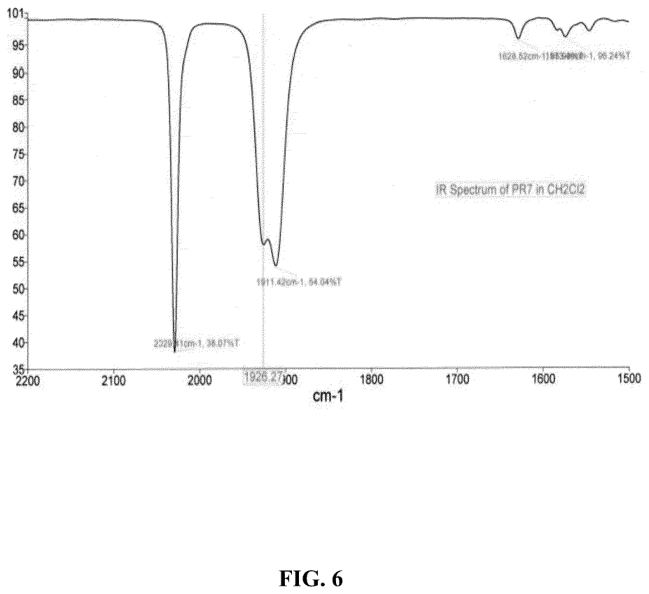

Referring to FIG. 3, Dirhenium decacarbonyl (Re2(CO)10) is refluxed with nitrogen—containing α-diimine ligands (N˜N) bathophenanthroline or bathocuproin to make pentylcarbonato complex precursors PC6 and PC7. Referring to FIG. 4, an equimolar mixture of the pentylcarbonato complex precursor (100 mg) and perrhenic acid in 15 mL of dichloromethane was prepared and allowed to stir for several hours. The reaction was monitored through IR spectroscopy, see FIGS. 5 and 6. When the reaction was complete, the solution was concentrated on a rotary evaporator. Hexane was added and cooled to −5° C. The yellow-orange crystalline PR complexes were obtained through filtration. The yields range from 70-80%.

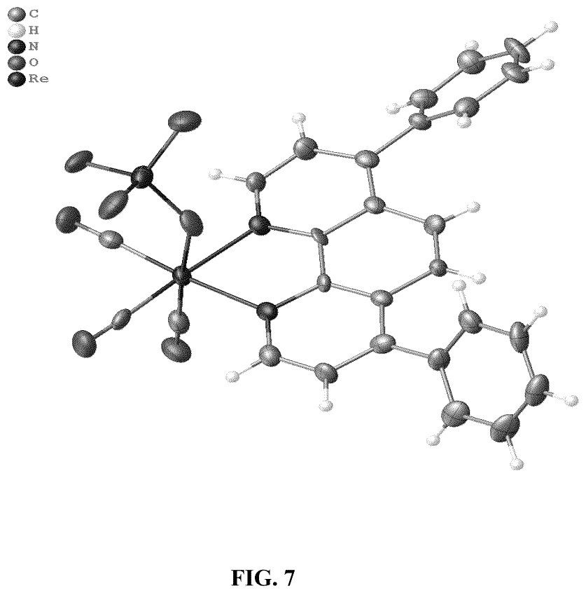

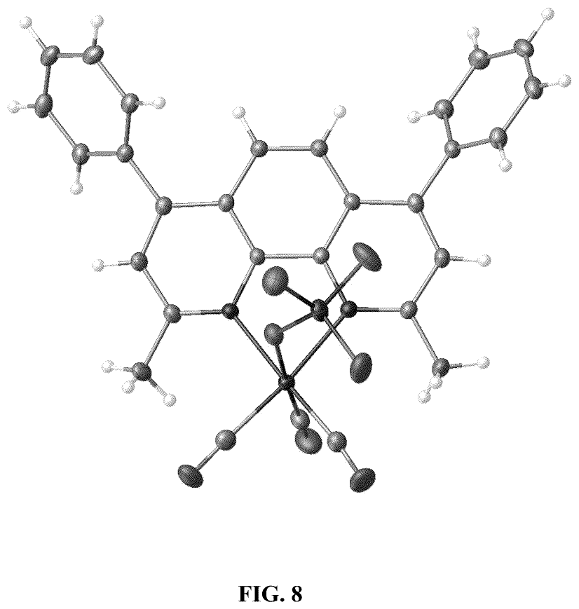

The structures of PR6 and P7 were confirmed by x-ray crystallography, see FIGS. 7 and 8. Crystal data and structure refinement for PR6 is shown in Appendix 1. Bond lengths and angles for PR6 are shown in Appendix 2. Torsion Angles for PR6 are shown in Appendix 3. Crystal data and structure refinement for PR7 is shown in Appendix 4. Bond lengths and angles for PR6 are shown in Appendix 5. Torsion Angles for PR6 are shown in Appendix 6.

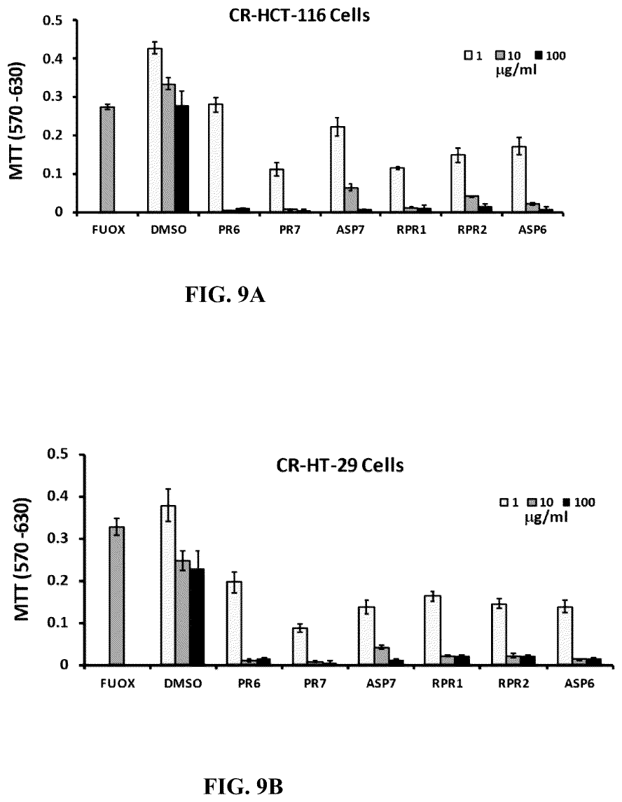

The MTT assay was used to measure cell activity and drug toxicity. The results demonstrate that PR6 and PR7 compounds have the ability to inhibit the growth of certain cancer cells. Specifically, in cultures of both CR-HCT-116 (FIG. 9A) and CR-HT-29 (FIG. 9B) colon cancer cell lines,, absorbance rates measured by a microplate reader at wavelengths ranging from 570 nm to 630 nm were very high for low concentrations (1 μ/ml) of cisplatin-PR6 and cisplatin-PR7 adduct formation.

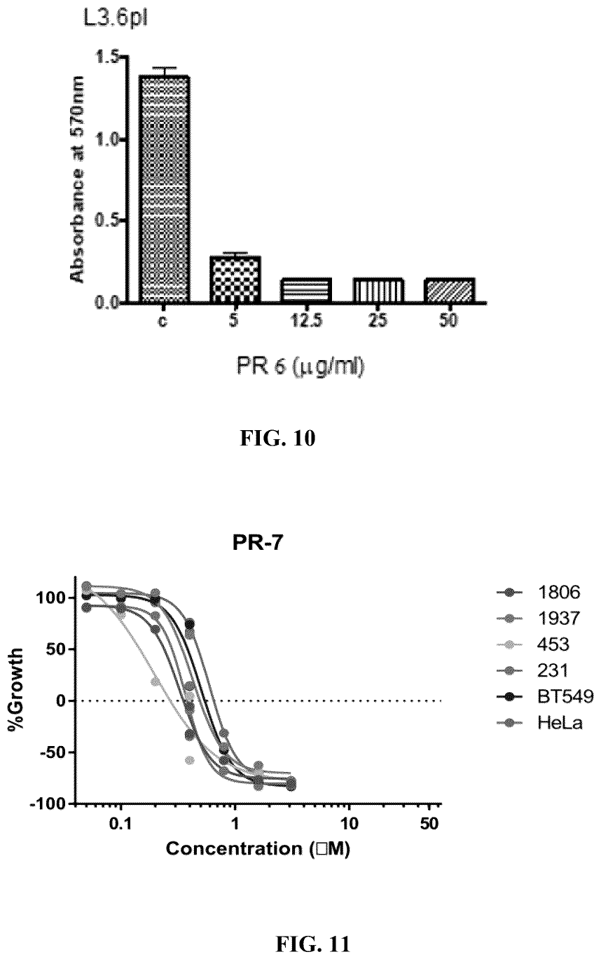

In a similar test relating to pancreatic cancer, small concentrations of a cisplatin-PR6 adduct formation resulted in very high absorbance rates at 570 nm, see FIG. 10.

As applied to six different cancer lines (HCC 1806, HCC 1937, MDA-MB 453, MDA-MB 231, BT549, and HeLa), certain concentrations of a cisplatin-PR7 adduct formation reduce growth of the cancer lines by 60%-80%, see FIG. 11.

It will be appreciated by those skilled in the art that changes could be made to the embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A compound of the formula:

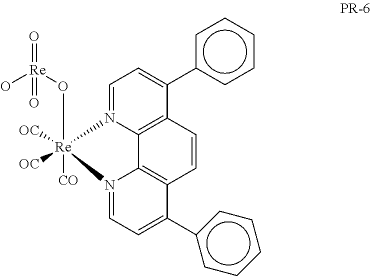

2. A compound of the formula: [chemical structure]
